(19) United States
(12) Patent Application Publication
(10) Pub. No.: US 2013/0341426 A1
(43) Pub. Date: Dec. 26, 2013

(54) FLEXIBLE LEAF SPRING SEAL FOR SEALING AN AIR GAP BETWEEN MOVING PLATES

(71) Applicants: Thomas M. Barry, JR., East Hampton, CT (US); Corina Scanio, Manchester, CT (US)

(72) Inventors: Thomas M. Barry, JR., East Hampton, CT (US); Corina Scanio, Manchester, CT (US)

(73) Assignee: UNITED TECHNOLOGIES CORPORATION, Hartford, CT (US)

(21) Appl. No.: 13/371,052

(22) Filed: Feb. 10, 2012

(51) Int. Cl. F02C 7/28

(52) U.S. Cl. CPC F02C 7/28
USPC 239/265.19; 277/500

(57) ABSTRACT

A sealed joint may include a first plate with a seal land, a second plate that moves relative to the seal land, and a leaf spring seal. The leaf spring seal includes a stack of seal leaf elements that extend laterally from a first stack end, which is connected to the second plate, towards a distal second stack end. The stack may include a seal land contact segment and a base segment. The seal land contact segment is engaged with the seal land, and spatially separated from the second plate. The base segment is configured laterally between the seal land contact segment and the first stack end, and spatially separated from the first plate. A first of the seal leaf elements has a first longitudinal length, and a second of the seal leaf elements has a second longitudinal length that is different than the first longitudinal length.

This invention was made with government support under Contract No. F33657-98-C-2004 awarded by the United States Air Force. The government may have certain rights in the invention.

### CROSS-REFERENCE TO RELATED APPLICATIONS

This application is related to U.S. Patent Application Ser. No. ______ (Attny. Docket No. ID-0018341-US), which is hereby incorporated by reference in its entirety, and is assigned to the assignee of the present invention.

### BACKGROUND OF THE INVENTION

1. Technical Field

The present invention relates generally to a flexible seal and, in particular, to a flexible seal for sealing an air gap between moving plates included in, for example, a turbine engine exhaust nozzle.

2. Background Information

A thrust vectoring exhaust nozzle may include an exhaust nozzle duct formed by an exhaust nozzle case and a plurality of convergent and divergent nozzle flaps. A seal may be arranged between each nozzle flap end and a respective exhaust nozzle case sidewall to reduce core gas leakage therebetween. Typical prior art seals, however, do not accommodate outward splaying of the exhaust nozzle case sidewalls.

### SUMMARY OF THE DISCLOSURE

According to a first aspect of the invention, a sealed joint includes a first plate with a seal land, a second plate that moves relative to the seal land, and a leaf spring seal. The leaf spring seal includes a stack of seal leaf elements that extend laterally from a first stack end, which is connected to the second plate, towards a distal second stack end. The stack includes a seal land contact segment and a base segment. The seal land contact segment is engaged with the seal land, and spatially separated from the second plate. The base segment is configured laterally between the seal land contact segment and the first stack end, and spatially separated from the first plate. Each of the seal leaf elements respectively includes an element length that extends longitudinally between a first element side and a second element side, and the element length of a first of the seal leaf elements is different than the element length of a second of the seal leaf elements.

According to a second aspect of the invention, a turbine engine exhaust nozzle includes an exhaust nozzle case with a seal land, an exhaust nozzle flap that moves relative to the seal land, and leaf spring seal. The leaf spring seal includes a stack of seal leaf elements that extend laterally from a first stack end, which is connected to the exhaust nozzle flap, to a distal second stack end. The stack includes a seal land contact segment that extends longitudinally between a first stack side and a second stack side. The seal land contact segment sealingly engages the seal land, and is separated from the exhaust nozzle flap by an air gap. A first of the seal leaf elements extends longitudinally from the first stack side to the second stack side, and a second of the seal leaf elements extends longitudinally from the first stack side partially towards the second stack side.

The foregoing features and the operation of the invention will become more apparent in light of the following description and the accompanying drawings.

### BRIEF DESCRIPTION OF THE DRAWINGS

FIG. 1 is a block diagram illustration of a gas turbine engine;

FIG. 2 is a side-view sectional illustration of a turbine engine exhaust nozzle;

FIG. 3 is a bottom-view sectional illustration of the exhaust nozzle illustrated in FIG. 2;

FIG. 4 is a cross-sectional illustration of a portion of the exhaust nozzle illustrated in FIG. 3;

FIG. 5 is a side-view illustration of a stack of seal leaf elements configured with a hinged mounting bracket;

FIG. 6 is an enlarged cross-sectional illustration of the stack of seal leaf elements illustrated in FIG. 5;

FIG. 7 is an exploded cross-sectional illustration of the stack of seal leaf elements illustrated in FIG. 6;

FIG. 8 is a bottom-view sectional illustration of a turbine engine exhaust nozzle during operation; and

FIG. 9 is a cross-sectional illustration of a portion of another turbine engine exhaust nozzle.

### DETAILED DESCRIPTION OF THE INVENTION

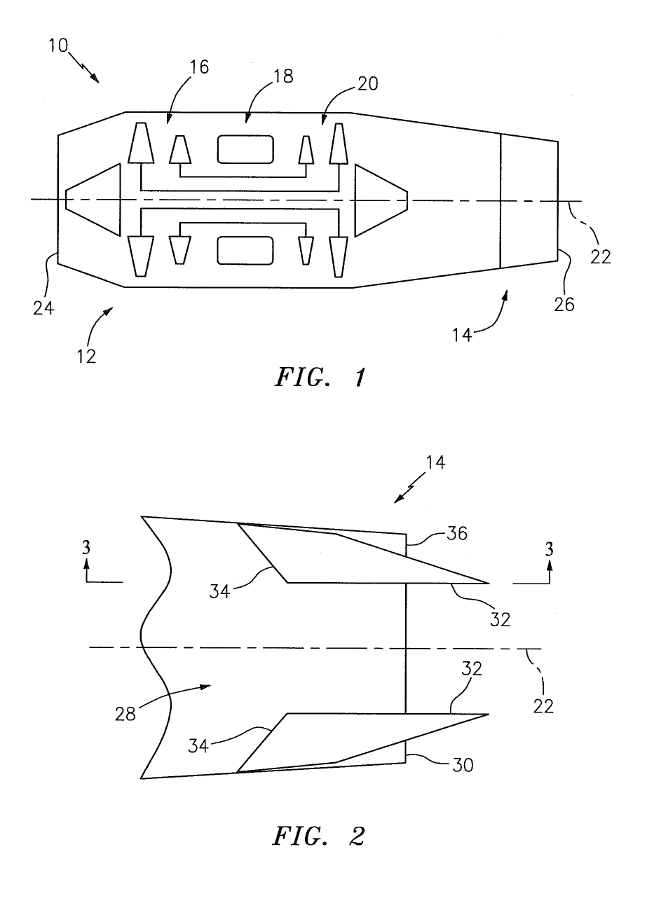

FIG. 1 is a block diagram illustration of a gas turbine engine 10 that includes an engine core 12 and a (e.g., thrust vectoring) exhaust nozzle 14. The engine core 12 includes a compressor section 16, a combustor section 18 and a turbine section 20. The engine core 12 and the exhaust nozzle 14 are sequentially arranged along a longitudinal centerline 22 between a turbine engine inlet 24 and a turbine exhaust nozzle outlet 26.

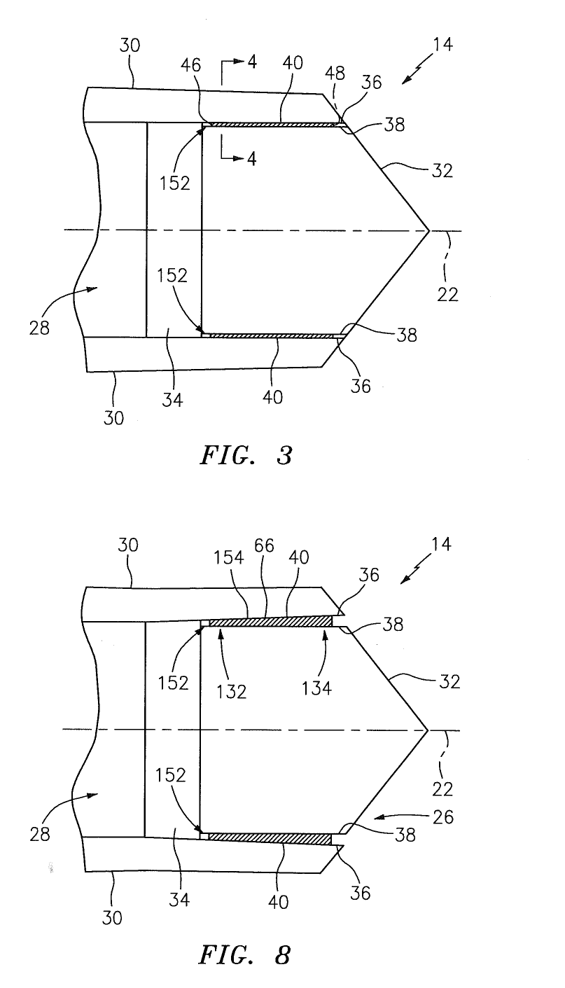

Referring to FIGS. 2 and 3, the exhaust nozzle 14 includes an exhaust nozzle duct 28 formed by an exhaust nozzle case 30 and one or more exhaust nozzle flaps (e.g., 32 and 34). The exhaust nozzle case 30 includes a plurality of first plates that are configured as, for example, exhaust nozzle duct sidewalls 36. The exhaust nozzle flaps may include one or more divergent flaps 32 and one or more convergent flaps 34. Each divergent flap 32 extends transversely between a plurality of second plates that are configured as, for example, divergent flap sidewalls 38. Examples of such an exhaust nozzle configuration are disclosed in U.S. Pat. Nos. 7,874,160 and 8,020,386, which are hereby incorporated by reference in their entirety, and assigned to the assignee of the present invention. The present invention, however, is not intended to be limited to any particular exhaust nozzle configuration. Referring still to FIG. 3, the exhaust nozzle 14 also includes one or more leaf spring seals 40.

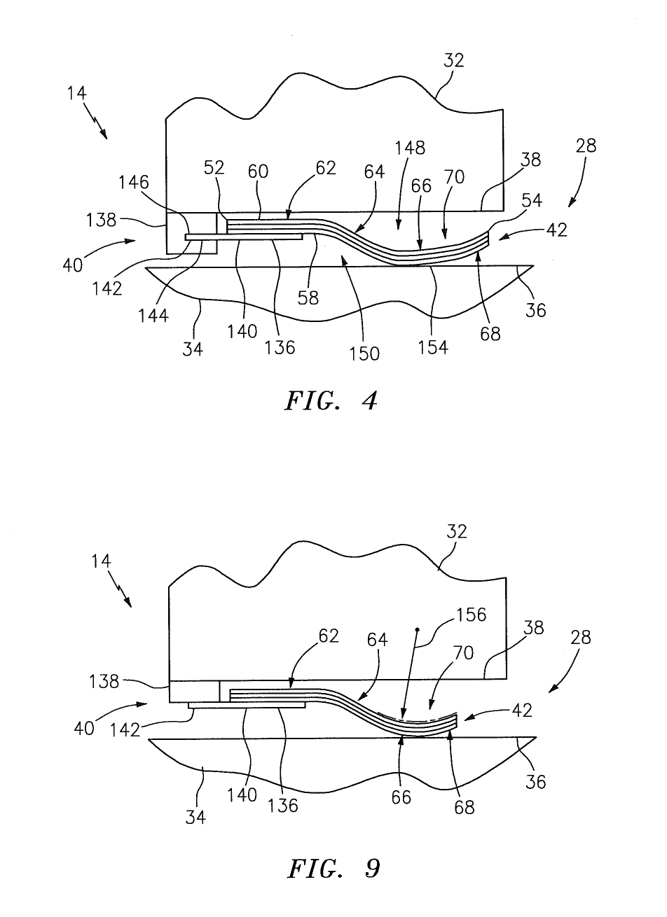

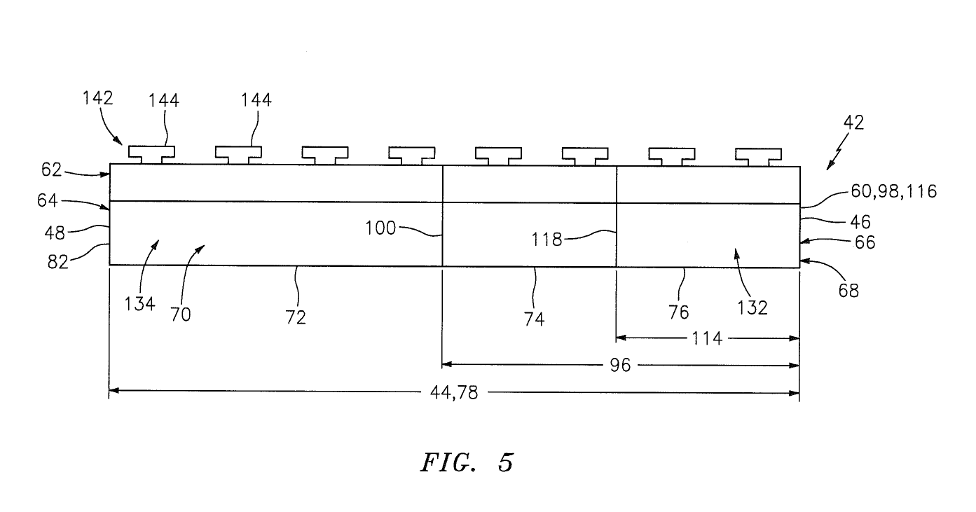

Referring to FIG. 4, each of the leaf spring seals 40 includes a stack 42 of a plurality of seal leaf elements. Referring to FIG. 5, the stack 42 has a stack length 44 that extends longitudinally between a first (e.g., forward) stack side 46 and a second (e.g., aft) stack side 48. Referring to FIG. 6, the stack 42 has a stack width 50 that extends laterally from a first stack end 52 to a distal second stack end 54. The stack 42 also has a stack thickness 56 that extends transversely between a sealing first stack surface 58 and a second stack surface 60.

Referring to FIGS. 5 and 6, the stack 42 may include a plurality of stack segments such as, for example, a base segment 62, a transition segment 64, a seal land contact segment 66 and a tip segment 68. Each of the respective segments 62, 64, 66 and 68 extends longitudinally between the first stack side 46 and the second stack side 48. The base segment 62 may extend laterally from the first stack end 52 to the transition segment 64. The transition segment 64, the seal land contact segment 66 and the tip segment 68 may be geometrically configured to faun a channel 70 that extends laterally between the base segment 62 and the second stack end 54. The transition segment 64, for example, may extend laterally and transversely (in a first direction) from the base segment 62 to the seal land contact segment 66. The seal land contact segment 66 may extend laterally from the transition segment 64 to the tip segment 68. The tip segment 68 may extend laterally and transversely (in a second direction opposite the first direction) from the seal land contact segment 66 to the second stack end 54. The channel 70 may have a cross-sectional geometry that extends longitudinally between the first stack side 46 and the second stack side 48.

In the leaf spring seal embodiment illustrated in FIG. 5, the stack 42 includes a first leaf element 72, a second leaf element 74, and a third leaf element 76. The first leaf element 72 has a first element length 78 that extends longitudinally from a first element side 80 to a second element side 82. The first element length 78 may be substantially equal to the stack length 44. Referring to FIG. 7, the first leaf element 72 has a first element width 84 that extends laterally from a first element end 86 to a distal second element end 88. The first element width 84 may be substantially equal to the stack width 50 (see FIG. 6). The first leaf element 72 also has a first element thickness 90 that extends transversely between a first element surface 92 and a second element surface 94.

Referring to FIG. 5, the second leaf element 74 has a second element length 96 that extends longitudinally from a first element side 98 to a second element side 100. The second element length 96 may be less than the first element length 78. Referring to FIG. 7, the second leaf element 74 has a second element width 102 that extends laterally from a first element end 104 to a distal second element end 106. The second element width 102 may be substantially equal to the stack width 50 (see FIG. 6). The second leaf element 74 also has a second element thickness 108 that extends transversely between a first element surface 110 and a second element surface 112. The second element thickness 108 may be substantially equal to the first element thickness 90. In alternative embodiments, however, the second element thickness 108 may be different (e.g., less or greater) than the first element thickness 90.

Referring to FIG. 5, the third leaf element 76 has a third element length 114 that extends longitudinally from a first element side 116 to a second element side 118. The third element length 114 may be less than the second element length 96. Referring to FIG. 7, the third leaf element 76 has a third element width 120 that extends laterally from a first element end 122 to a distal second element end 124. The third element width 120 may be substantially equal to the stack width 50 (see FIG. 6). The third leaf element 76 also has a third element thickness 126 that extends transversely between a first element surface 128 and a second element surface 130. The third element thickness 126 may be substantially equal to the first element thickness 90 and/or the second element thickness 108. In alternative embodiments, however, the third element thickness 126 may be different (e.g., less or greater) than the first element thickness 90 and/or the second element thickness 108.

Referring to FIG. 6, the second leaf element 74 is arranged transversely between the first leaf element 72 and the third leaf element 76. Referring to FIG. 5, the first leaf element 72, the second leaf element 74 and the third leaf element 76 may be longitudinally aligned to provide the stack with a spring stiffness that changes (e.g., decreases) along the stack length 44. For example, the first element sides 80, 98 and 116 may be arranged at (e.g., longitudinally aligned with) the first stack side 46, which staggers the second element sides 82, 100 and 118 respectively along the stack length 44. In such a configuration, a first region 132 of the stack 42 adjacent the first stack side 46 may have a greater spring stiffness than a second region 134 of the stack 42 adjacent the second stack side 48. Referring to FIG. 6, the first element ends 86, 104, 122 may be connected (e.g., mechanically fastened, braised, welded, etc.) together at the first stack end 52. The second element ends 88, 106 and 124 may be slidingly engaged with one another to permit lateral movement between the leaf elements 72, 74 and 76, which may dampen exhaust nozzle 14 vibrations during turbine engine 10 operation.

Referring to FIG. 4, each of the leaf spring seals 40 may also include a (e.g., hinged) mounting bracket 136 and/or a seal mount 138. The mounting bracket 136 may include a bracket base segment 140 that is laterally connected to a bracket mounting segment 142. Referring to FIGS. 4 and 5, the bracket mounting segment 142 may include one or more (e.g., T-bar) hinges 144 that are longitudinally arranged along the bracket base segment 140.

Referring to FIG. 4, the bracket base segment 140 may be engaged with the first stack surface 58 at the first stack end 52, and connected (e.g., riveted, braised, welded, etc.) to the base segment 62. The hinges 144 may be mated with one or more corresponding hinge apertures 146 in the seal mount 138 in a manner that, for example, cantilevers the stack 42 from the seal mount 138. The seal mount 138 is connected to a respective divergent flap sidewall 38. The first stack surface 58 at the seal land contact segment 66 engages (e.g., sealingly contacts) a seal land 154 on the respective exhaust nozzle duct sidewall 36. A first air gap 148 extends transversely between the respective divergent flap sidewall 38 and one or more of the stack segments such as, for example, the base segment 62, the transition segment 64, the seal land contact segment 66 and the tip segment 68. One or more second air gaps 150 extends transversely between the respective exhaust nozzle duct sidewall 36 and one or more of the stack segments such as, for example, the base segment 62, the transition segment 64 and the tip segment 68.

Referring to FIG. 1, during turbine engine 10 operation, the exhaust nozzle 14 receives core gas from the engine core 12. Referring to FIGS. 2 and 3, the exhaust nozzle duct 28 directs a relatively large portion of the core gas through the turbine exhaust nozzle outlet 26 to provide engine thrust. A relatively small portion of the core gas, however, may leak from the exhaust nozzle duct 28 into joints 152 between the exhaust nozzle duct sidewalls 36 and the divergent flap sidewalls 38. Referring to FIG. 4, this small portion of the core gas may flow into the first air gap 148 and exert a pressure force against the stack 42. The pressure force may push the seal land contact segment 66 against the respective seal land 154.

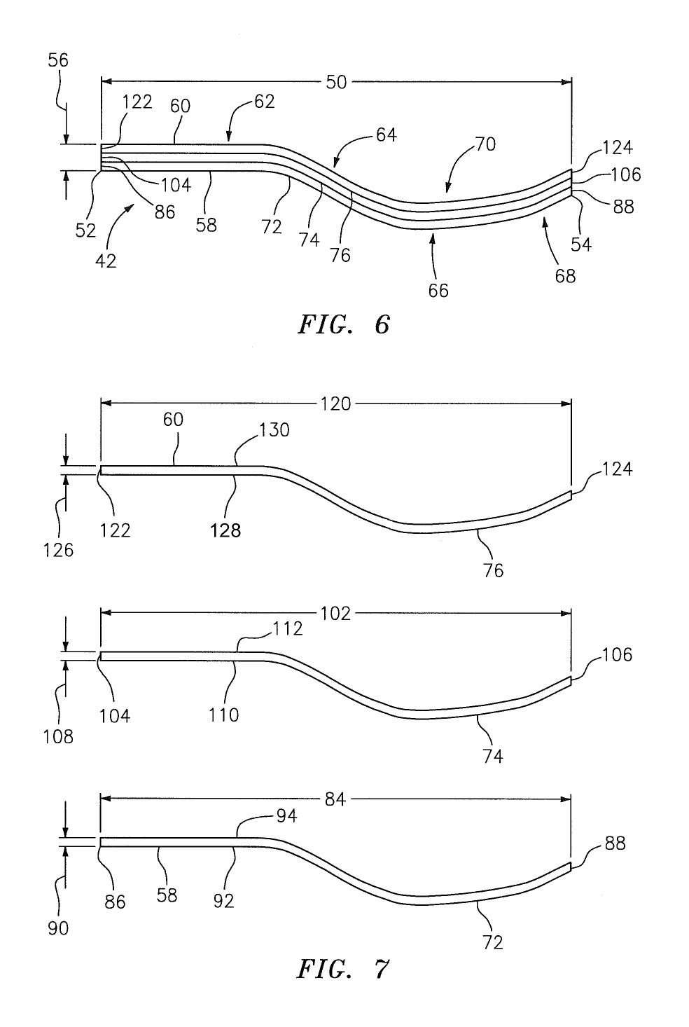

Referring to FIG. 8, during some operating conditions, the exhaust nozzle duct sidewalls 36 may (e.g., outwardly) splay apart from one another. Such splaying may non-uniformly increase displacement between each exhaust nozzle duct sidewall 36 and the respective divergent flap sidewall 38 as the exhaust nozzle 14 extends longitudinally aft towards the turbine exhaust nozzle outlet 26.

Referring to FIGS. 5 and 6, the seal leaf elements 72, 74 and 76 in each stack 42 may be sized and arranged, as described above, to provide the first (e.g., forward) stack side 46 with the relatively large spring stiffness and the second (e.g., aft) stack side 48 with the relatively small spring stiffness. Referring again to FIG. 8, the relatively large spring stiffness may be selected such that the pressure force of the leaked core gas displaces the seal land contact segment 66 in the first region 132 a relatively small distance. The relatively small spring stiffness, on the other hand, may be selected such that the pressure force of the leaked core gas displaces the seal land contact segment 66 in the second region 134 a relatively large distance. In this manner, each leaf spring seal 40 may accommodate the non-uniform displacement between the respective exhaust nozzle duct sidewall 36 and divergent flap sidewall 38, and maintain a seal between the seal land contact segment 66 and the seal land 154.

In some embodiments, for example as illustrated in FIG. 4, the transition segment 64, the seal land contact segment 66 and/or the tip segment 68 may be geometrically configured to provide the channel 70 with a (e.g., curved) compound cross-sectional geometry. In other embodiments, for example as illustrated in FIG. 9, the transition segment 64, the seal land contact segment 66 and/or the tip segment 68 may be geometrically configured to provide the channel 70 with an curved (e.g., arcuate) cross-sectional geometry having, for example, a substantially constant radius 156. In still other embodiments, the one of more of the stack segments may be geometrically configured to provide the channel with an angular compound cross-sectional geometry. In still other embodiments, the stack may be geometrically configured without the channel The present invention, however, is not intended to be limited to any of the aforesaid stack configurations.

In some embodiments, the stack 42 may be sized and geometrically configured to preload the seal land contact segment 66 against the seal land 154.

In some embodiments, for example as illustrated in FIG. 9, the stack 42 may be rigidly connected to the seal mount 138. The bracket mounting segment 142, for example, may be connected (e.g., mechanically fastened, braised, welded, etc.) to the seal mount 138. In other embodiments, the stack may be connected (e.g., mechanically fastened, braised, welded, etc.) directly to the divergent flap sidewall. In still other embodiment, the stack may be connected to the exhaust nozzle duct sidewall, and the seal land contact segment may engage a seal land on the divergent flap sidewall.

In some embodiments, the second element sides may be arranged at (e.g., longitudinally aligned with) the second (e.g., aft) stack side, which staggers the first element sides respectively along the stack length. In such a configuration, the first region of the stack adjacent the first (e.g., forward) stack side may have a smaller spring stiffness than the second region of the stack adjacent the second (e.g., aft) stack side. In other embodiments, the first and second element sides may be staggered along the stack length to provide the stack with a longitudinal intermediate region having a greater spring stiffness than the first region and/or the second region.

The leaf spring seals are described above and illustrated in the drawings as being included in a turbine engine exhaust nozzle. A person of ordinary skill in the art will recognize, however, that such a leaf spring seal may be utilized to seal a gap between moving plates in a variety of different applications. The present invention therefore is not intended to be limited to turbine engine exhaust nozzle or turbine engine applications.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

What is claimed is:

1. A sealed joint, comprising:
a first plate comprising a seal land;
a second plate that moves relative to the seal land; and
a leaf spring seal comprising a stack of a plurality of seal leaf elements that extend laterally from a first stack end that is connected to the second plate towards a distal second stack end, the stack comprising a seal land contact segment that engages with the seal land and is spatially separated from the second plate, and a base segment that is configured laterally between the seal land contact segment and the first stack end, and spatially separated from the first plate;
wherein each of the plurality of seal leaf elements respectively comprises an element length that extends longitudinally between a first element side and a second element side, and the element length of a first of the plurality of seal leaf elements is greater than the element length of a second of the plurality of seal leaf elements.

2. The joint of claim 1, wherein the stack extends longitudinally between a first stack side and a second stack side, and the first element side of the first of the plurality of seal leaf elements and the first element side of the second of the plurality of seal leaf elements are arranged at the first stack side.

3. The joint of claim 1, wherein each of the plurality of seal leaf elements extends laterally between the first stack end and the second stack end.

4. The joint of claim 1, wherein one of the plurality of seal leaf elements comprises a first thickness, and another one of the plurality of seal leaf elements comprises a second thickness that is different than the first thickness.

5. The joint of claim 1, wherein each of the plurality of seal leaf elements respectively extends laterally from the first stack end to a distal second element end, and the second element end of one of the plurality of seal leaf elements is slidingly engaged with the second element end of another one of the plurality of seal leaf elements.

6. The joint of claim 1, wherein the stack further comprises a transition segment that extends laterally between the base segment and the seal land contact segment, and the transition segment is spatially separated from the first plate and the second plate.

7. The joint of claim 6, wherein the stack further comprises a tip segment that extends laterally from the seal land contact segment to the second stack end, and the tip segment is spatially separated from the first plate and the second plate.

8. The joint of claim 7, wherein the transition segment, the seal land contact segment and the tip segment form a channel that extends longitudinally between the first stack side and the second stack side.

9. The joint of claim 8, wherein the channel comprises a curved cross-sectional geometry.

10. The joint of claim 9, wherein the curved cross-sectional geometry comprises a substantially constant radius.

11. The joint of claim 1, wherein the seal land contact segment is preloaded against the seal land.

12. The joint of claim 1, wherein the plurality of seal leaf elements are laterally cantilevered from a seal mount that is connected to the second plate.

13. The joint of claim 12, wherein the leaf spring seal further comprises a hinged mounting bracket that connects the plurality of seal leaf elements to the seal mount.

14. A turbine engine exhaust nozzle, comprising:
an exhaust nozzle case comprising a seal land;
an exhaust nozzle flap that moves relative to the seal land;
a leaf spring seal comprising a stack of a plurality of seal leaf elements that extend laterally from a first stack end that is connected to the exhaust nozzle flap to a distal second stack end, the stack comprising a seal land contact segment that extends longitudinally between a first stack side and a second stack side;
wherein the seal land contact segment sealingly engages the seal land, and is separated from the exhaust nozzle flap by an air gap; and
wherein a first of the plurality of seal leaf elements extends longitudinally from the first stack side to the second stack side, and a second of the plurality of seal leaf elements extends longitudinally from the first stack side partially towards the second stack side.

15. The exhaust nozzle of claim 14, wherein one of the plurality of seal leaf elements comprises a first thickness, and another one of the plurality of seal leaf elements comprises a second thickness that is different than the first thickness.

16. The exhaust nozzle of claim 14, wherein
the stack further comprises a transition segment that extends laterally between a base segment and the seal land contact segment;
the transition segment is separated from the exhaust nozzle flap by the air gap and from the exhaust nozzle case by a second air gap; and
the base segment is connected to the exhaust nozzle flap and separated from the exhaust nozzle case by the second air gap.

17. The exhaust nozzle of claim 16, wherein
the stack further comprises a tip segment that extends laterally from the seal land contact segment to the second stack end; and
the tip segment is separated from the exhaust nozzle flap by the air gap and from the exhaust nozzle case by the second air gap.

18. The exhaust nozzle of claim 17, wherein the transition segment, the seal land contact segment and the tip segment form a channel that extends longitudinally between the first stack side and the second stack side.

19. The exhaust nozzle of claim 18, wherein the channel comprises a curved cross-sectional geometry.

20. The exhaust nozzle of claim 14, wherein the plurality of seal leaf elements are laterally cantilevered from a seal mount that is connected to the exhaust nozzle flap.
